(19) United States
(12) Patent Application Publication
(10) Pub. No.: US 2006/0254984 A1
(43) Pub. Date: Nov. 16, 2006

(54) Hollow Fiber Membrane Adsorber and Process for the Use Thereof

(75) Inventor: Yuriy S. Polyakov, Ashland, PA (US)

Correspondence Address: USPOLYRESEARCH, 906 SPRUCE ST., ASHLAND, PA, 17921, US

(73) Assignee: USPolyResearch, Ashland, PA (US)

(21) Appl. No.: 11/380,637

(22) Filed: Apr. 27, 2006

Related U.S. Application Data
(60) Provisional application No. 60/681,056, filed on May 16, 2005.

(51) Int. Cl. B01D 61/00

(52) U.S. Cl. 210/650; 210/805; 210/321.6

(57) ABSTRACT

There is disclosed a micro- or ultrafiltration process using a membrane module consisting of hollow fiber, tubular, or capillary membranes, comprising feeding the liquid to be treated in the space between the membranes; withdrawing the permeate, a product stream which is obtained by passing the liquid under the action of pressure gradient through the pores of said membranes from the outsides thereof to the insides thereof to trap the colloidally suspended particles on the outer surfaces and/or inside the pores of said membranes, from the inside of said membranes; withdrawing the filtrate, a product stream which is obtained by collection of said particles on the outside surface of said membranes due to adsorption and/or other particle collection mechanisms, under the action of pressure difference across a control valve, or any other flow control device, at the filter outlet.

### CROSS-REFERENCE TO RELATED APPLICATIONS

This application claims the benefit of U.S. Provisional Patent Application No. 60/681,056 filed May 16, 2005.

### DESCRIPTION

### Terms Used in the Invention

To avoid any misunderstanding of the present invention both itself and in comparison with the current state of the art, the following terms deserve explanation to be properly understood throughout this description.

Definition List 1

| Term | Definition |
|---|---|
| A product stream | a stream of clarified liquid exiting a filter |
| A permeate | a product stream obtained by passing a |
| | liquid through semipermeable |
| | membranes |
| A filtrate | a product stream obtained due to |
| | collection of suspended particles on the |
| | outside surface (shell) of semipermeable |
| | membranes by adsorption and/or other |
| | particle collection mechanisms |
| A dead-end filter | a filter with a single exit stream, |
| | permeate |

### BACKGROUND OF THE INVENTION

Microfiltration (MF) and ultrafiltration (UF), in which a semipermeable porous membrane is used to clean a slurry from the suspended particles, macromolecules, fine solids or viruses, are often accompanied by the formation of a cake on the membrane surface (“Membrane Handbook”, Winston Ho W. S, Sirkar K. K., Eds., 1992; Cheryan M. “Ultrafiltration and Microfiltration Handbook”, 1998; Zeman L. J. and Zydney A. L. “Microfiltration and Ultrafiltration: Principles and Applications”, 1996). The hydraulic resistance of the cake, which may dramatically reduce the process driving force, is considered to be the factor limiting, or narrowing, the industrial and municipal application of microfiltration and ultrafiltration, for example, to wastewater and surface-water treatment.

Membrane fouling in UF/MF is a problem that has been attracting considerable intellectual and engineering resources over almost 40 years. A lot of efforts, such as high tangential flows, vibration, air sparging, and the like, have been taken to minimize its negative impact on the performance of UF/MF filters (Wang S., Membr. Q., 2005, vol. 20, no. 1, pp. 7-11). All these efforts are associated with increased operating, maintenance, and capital costs, and, as a result, UF/MF is still not competitive with conventional technologies for most applications in water and wastewater treatment.

The use of semipermeable membranes in various forms for solid-liquid separations is well known. Generally, one or several components of the feed slurry permeate through the membrane and are collected as permeate. The slurry components rejected by the membrane are retained at its surface, some forming a cake and the rest being carried away by the stream of retentate to be discharged from the filter, while fresh portions of the slurry to be separated are supplied to the membrane. To reduce the particle deposition rate in commercial UF and MF filters, their membranes are manufactured of materials with low adsorptive capabilities. Unfortunately, the latter ones often do not show high mechanical strength and chemical resistance, which are required by many water treatment applications (“Membrane Handbook”. Winston Ho W. S, Sirkar K. K., Eds. I, 1992; Cheryan M. “Ultrafiltration and Microfiltration Handbook”, 1998; Zeman L. J. and Zydney A. L. “Microfiltration and Ultrafiltration: Principles and Applications”, 1996).

Membranes formed as hollow fibers or tubes are particularly useful because they are inherently strong enough to resist transmembrane pressure, which is the driving force of UF and MF. Also, they provide high ratios of membrane surface area to filter volume and can readily be arranged in various mechanical mountings. Conventionally, UF and MF hollow fiber modules are configured as long cylinders with hollow fiber membranes arranged in an axial direction (shell-and-tube or U-tube configuration) and terminated by plugs of potting material between and around the fibers.

In the existing hollow-fiber membrane devices, the slurry to be separated may be supplied to the outside surface (shell) of hollow fibers, and the permeate may be collected from the inside (lumen) of the fibers. In few devices, the retentate is also withdrawn. Alternatively, the slurry to be separated may be supplied into the lumen of the fibers, and the permeate drained from their shells. In the latter devices, the retentate is withdrawn from the opposite ends of the hollow fibers.

U.S. Pat. No. 5,871,649 provides an improved affinity membrane device and method for the effective removal of target molecules in blood plasma by adsorbing them on the adsorbing sites made on the inside surface of membrane pores as the blood plasma flows through the pores. The device consists of hollow fiber membranes having specified dimensions and transfer properties, ligand immobilized to the inside pore surface of the hollow fibers, and a housing to encase the hollow fibers and allow appropriate entry and exit of the blood.

U.S. Pat. No. 6,174,443 relates to a microporous or macroporous affinity filtration membrane wherein the matrix of the membrane is composed of chitin and the pores are made by dissolution of porogen during the preparation of the membrane. The invention relates to the area of affinity purification of macromolecules. More particularly, the invention provides an affinity membrane, wherein the pore size is based upon the size of the porogen selected, a method for preparation of the membrane, and a method for affinity purification of macromolecules.

U.S. Pat. No. 5,024,762 provides a method of concentrating solids in a liquid suspension using a filter having a plurality of hollow microporous, elastic fibers with a housing, comprising applying the suspension to an outer surface of the fibers whereby a portion of the suspension passes through the fiber walls and at least a portion of the solids is retained on or in the fibers; and discharging the retained solids by stretching the fiber pores and washing out solids retained in the pores by application of gas under pressure.

U.S. Pat. No. 5,922,201 provides a hollow fiber membrane module comprising hollow fibers, a fastening member for fixing the ends of the hollow fibers while leaving them open, and a structural member for enclosing and supporting the fastening member, the hollow fiber membrane module being useful in the filtration of water by suction from the surface to the inside of the hollow fibers with intermittent or continuous cleaning of the membrane surfaces of the hollow fibers.

U.S. Pat. No. 5,560,828 relates to a process for the removal of components causing turbidity, from a fluid, by means of microfiltration, whereby the fluid is beer, wine, fruit juice, bacterial suspension, blood, milk, enzyme suspension, etc. According to the invention, the fluid to be treated is fed across an asymmetric membrane having a pore structure such that the pores on the feed side of the membrane are larger than the nominal pore size and the pores of nominal pore size occur in the cross section toward the permeate side, the filtered off components are back-flushed from the membrane and are subsequently carried away with the fluid.

U.S. Pat. No. 5,456,843 relates to a microfiltration and/or ultrafiltration polymer membrane the special feature of which is that the matrix of the membrane incorporates an active adsorbent. Preferably the membrane, which can be tubular, flat or capillary, is hydrophilic and is usually asymmetric or is constructed of different layers.

U.S. Pat. No. 6,113,792 provides a method in which heated iron oxide particles are combined with membrane filtration to remove contaminants from water. The use of the heated particles reduces fouling of the membrane typically encountered when membranes alone are used to remove contaminants from water.

U.S. Pat. No. 4,959,152 relates to an apparatus for the separation of a fluid into permeate and retentate portions. The apparatus provides a plurality of hollow fiber separation wafers, each wafer comprising a mat of hollow fibers. The invention also provides a separation method including the steps of feeding the fluid into a module containing a plurality of hollow fibers arranged chord-wise in parallel sheets, each sheet being oriented perpendicularly with respect to the longitudinal axis of the module; providing separate chambers for the permeate, communicating with the lumens of the hollow fibers, and for the retentate, communicating with the areas between the hollow fibers; and removing the permeate and retentate from the module.

U.S. Pat. No. 5,032,269 relates to a hollow fiber module with at least one bundle of hollow fibers made in a U-shape, in which each hollow fiber bundle comprises at least two part bundles of different average lengths, the hollow fibers arranged essentially in the form of layers at least in the region of the bend of the U shape, the layers extending substantially parallel to the longitudinal axis of the module, the longitudinal axes of the layers and the longitudinal axis of the module approximately coinciding and the layers forming an angle between them when viewed longitudinally.

### SUMMARY OF THE INVENTION

It is an object of the present invention to provide a hollow-fiber membrane filtration process that is more cost-effective compared to traditional dead-end and crossflow micro- and ultrafiltration due to an additional (to permeate) clarified product stream, filtrate, which is obtained by collection of colloidally suspended particles on the outside surface of hollow fibers due to adsorption and/or other particle collection mechanisms.

It is another object of the invention to provide a membrane filtration system with a liquid phase recovery from feed mixture and particle retention that are close to 100%.

Yet, it is another object of the invention to provide a micro- and ultrafiltration process that can be effected at both constant transmembrane pressure and constant feed flow rate by using a control valve installed at the filtrate outlet that compensates for the decline in permeate flow rate by increasing the filtrate flow rate.

And still, it is another object of the invention to widen a range of polymers and other materials that can be used for hollow fibers by allowing the use of membranes with high adsorptive capabilities with respect to colloidally suspended particles.

According to one aspect of the present invention, there is provided a micro- or ultrafiltration process using a membrane module consisting of hollow fiber, tubular, or capillary membranes, comprising (a) feeding the liquid to be treated in the space between the membranes; (b) withdrawing the permeate, a product stream which is obtained by passing the liquid under the action of pressure gradient through the pores of said membranes from the outsides thereof to the insides thereof to trap the colloidally suspended particles on the outer surfaces and/or inside the pores of said membranes, from the inside of said membranes; (c) withdrawing the filtrate, a product stream which is obtained by collection of said particles on the outside surface of said membranes due to adsorption and/or other particle collection mechanisms, under the action of pressure difference across a control valve, or any other flow control device, at the filter outlet.

According to another aspect of the present invention, there is provided a filtration system with multiple stages of this process, wherein the filtrate on the previous stage is used as the feed for the following stage until the last stage.

### BRIEF DESCRIPTION OF THE DRAWINGS

FIG. 1. Radial hollow fiber membrane adsorber: 1-feed, 2-hollow fiber, 3-filtrate, 4-permeate, 5-control valve.

FIG. 2, 3. Profiles of dimensionless concentration of suspended particles C and dimensionless specific deposit y (mass of deposited particles per unit membrane outside surface area) in a hollow fiber membrane adsorber (t the filtration time, Z the dimensionless filter depth coordinate).

FIG. 4. Three-stage process flow diagram: 1, 9-12, 14-17, 19, 20, 22, 25-shutoff valve; 2, 21, 24-control valve; 3-first-stage hollow fiber membrane module; 4-feed tank; 5-first-stage filtrate tank; 6-second-stage filtrate tank; 7-first-stage pump; 8-permeate tank, 13-second-stage pump; 18-second-stage hollow fiber membrane module; 23-third-stage hollow fiber membrane module; 26-third-stage pump.

### BEST MODE FOR CARRYING OUT THE INVENTION

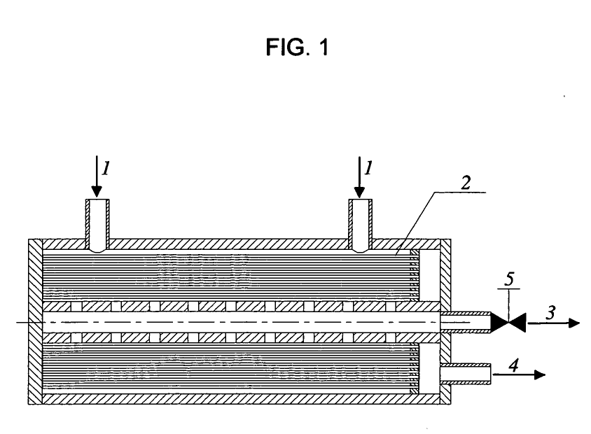

A hollow fiber membrane (HFM) filter with two clarified product streams, permeate and filtrate, in which the feed suspension is supplied to the HFM shells, where the suspended particles are deposited, is shown in FIG. 1. The distinctive feature of such a hollow fiber membrane adsorber is an additional product stream, filtrate 3, produced due to the particle collection on the HFM surfaces. The adsorber does not have any retentate stream, as do all conventional cross-flow UF and MF filters. The feasibility of the proposed process design can be assessed from physical considerations as follows:

First, the HFM packing densities in the existing filters are up to 0.5-0.6, which is close to those of adsorbent columns and filtration beds. HFM filters show a highly developed membrane surface and very low flow velocities of slurry tangential to membrane surface, which is good for particle deposition. The collection efficiency of such an adsorber can be enhanced by the permeation drag, which brings the suspended particles to the membrane surface.

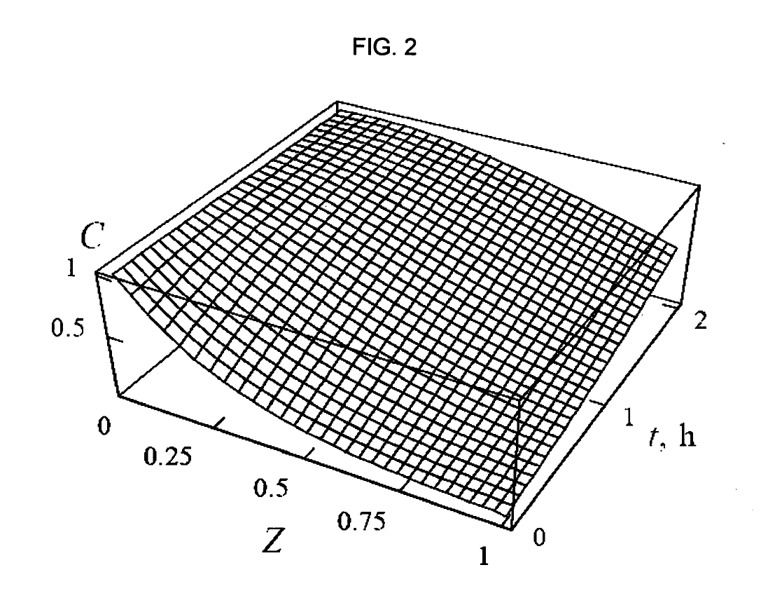

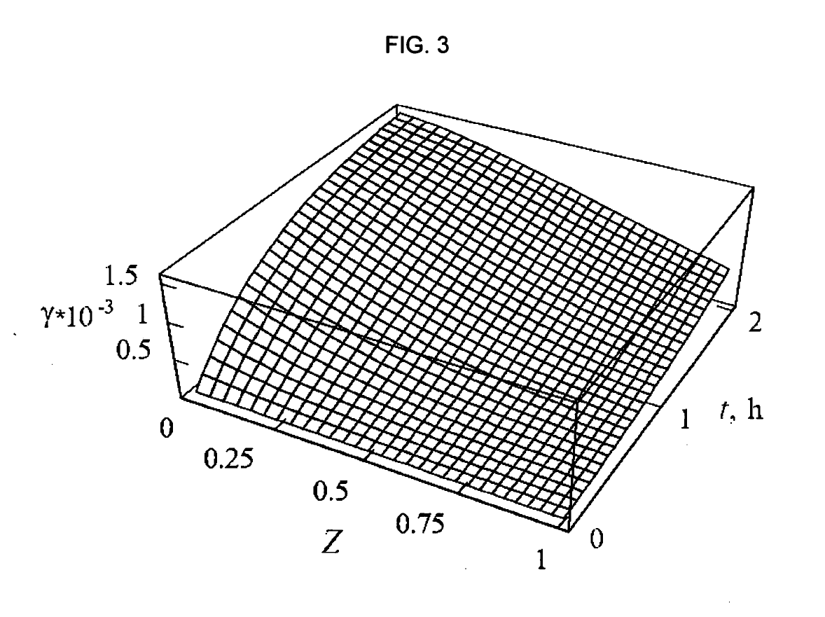

Second, it is common knowledge that suspended particles (SP) in adsorbent columns are initially collected by the entrance layers of grains, and the particle deposition front moves on to the deep layers. The operation is terminated when a breakthrough takes place. So, the same process will take place in the HFM adsorber: the outer hollow fibers collect the suspended particles while the inner ones remain almost clean, keeping their permeate velocity at a high level (FIG. 2, 3). Clearly, during the initial period the SP concentration in the filtrate will be low, so the filtrate can be withdrawn, increasing the total yield of clarified water in the filter. Potentially, this gives us a chance to build an outside-in HFM filter providing a constant product flow rate at constant transmembrane pressure (TMP), with a power consumption close to that of a deadend filter with the same design parameters and a single clarified water stream, permeate, declining in time.

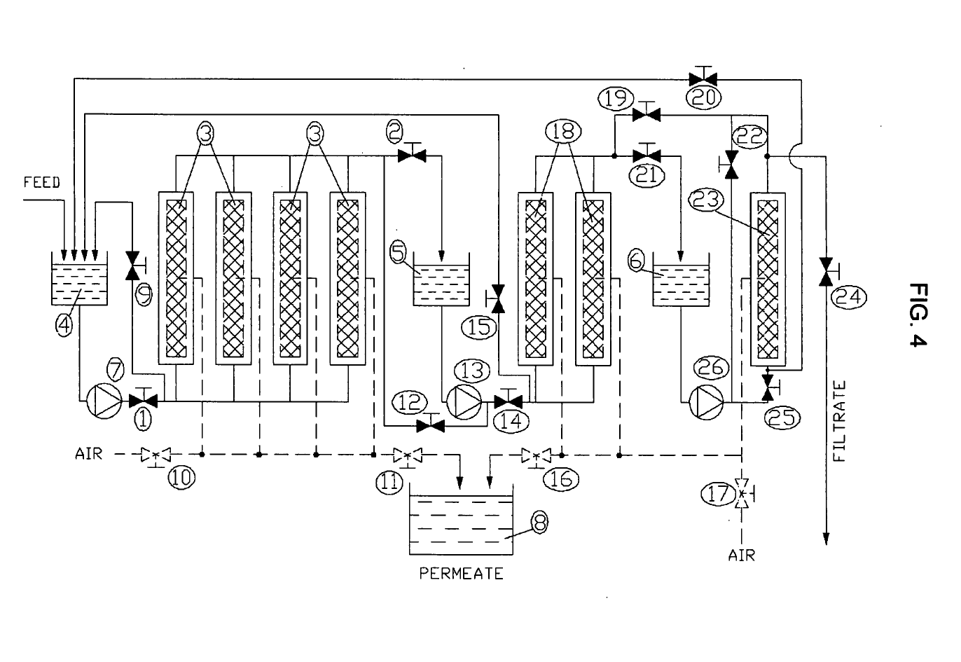

Third, the filtrate leaving an HFM adsorber can be used as a feed to another HFM adsorber, which allows us to achieve very high SP retentions and water recoveries (FIG. 4). At the same time, conventional crossflow UF/MF devices have a retentate stream, in which the SP concentration is higher than that in the feed. It is well known that the higher the SP concentration in the feed, the higher the rate of cake deposition and the lower the permeate velocity. This limitation of conventional crossflow UF/MF plants makes it impossible to achieve high enough values of particle retention and water recovery.

Fourth, a wide range of polymers and other materials that do not possess low adsorptive capabilities, such as hydrophobic polyethersulfons, polyvinylidene fluorides, and the like, and, according to the classical theory, should not be used to manufacture UF/MF membranes (Cheryan M. “Ultrafiltration and Microfiltration Handbook”, 1998; Zeman L. J. and Zydney A. L. “Microfiltration and Ultrafiltration: Principles and Applications”, 1996) could find a way to the market of HFM adsorbers. As a result, membrane technologists would get a chance to build processes that will provide more effective and stronger hollow fibers.

Fifth, the adsorptive properties of the body of specially prepared MF and UF hollow fiber membranes are already successfully used in affinity filtration and membrane chromatography, where a wide network of immobilized ligands, or incorporated ion-exchange particles, with a highly developed surface due to extremely high porosity of the semipermeable membranes, accomplishes substance-specific treatment in the purification of protein solutions.

To evaluate the above physical considerations into numbers and relations, a special study was carried out (Polyakov Yu. S. “Ultra- and Microfiltration in Hollow Fiber Filters with Cake Deposition on Membrane Surface”, PhD dissertation, 2004; Polyakov Yu. S. and Kazenin D. A., Theor. Found. Chem. Eng., 2005, vol. 39, no. 2, pp. 118-128; Polyakov Yu. S. and Kazenin D. A., Theor. Found. Chem. Eng., 2005, vol. 39, no. 4, pp. 402-406; Polyakov Yu. S., Theor. Found. Chem. Eng., 2005, Vol. 39, No. 5, pp. 471-477; Polyakov Yu. S., Membr. Q., 2005, vol. 20, No. 3, pp. 7-11; Polyakov Yu. S., J. Membr. Sci., 2006 [doi:10.1016/j.memsci.2005.10.054]; Polyakov Yu. S., J. Membr. Sci., 2006 [doi:10.1016/j.memsci.2006.02.019]; Polyakov Yu. S., J. Membr. Sci., 2006 [doi:10.1016/j.memsci.2005.12.056]).

To simulate the operation of an outside-in HFM filter, the conventional mathematical model developed for adsorbent columns and granular beds (Tien C. “Granular filtration of aerosols and hydrosols”, 1989) was used. The governing equations were modified to take into account the withdrawal of permeate as the suspension moves from the outer to inner hollow fibers, and the dependence of permeate velocity on the thickness of cake layer. The initial condition of clean filter was assumed.

The ranges of values of unknown coefficients involved in the model were determined by approximating the data of two experimental studies with deadend outside-in HFM filters treating activated sludge. The first experiment was run on a laboratory HFM module with an initial permeate velocity of 250 I/(m²h) (Lim A. L. and Bai R., J. Membr. Sci. 2003, vol. 216, nos. 1-2. p. 279). The second study included pilot experiments at three different TMP values: 20, 40 and 60 kPa (Benitez J. et al., Wat. Res., 1995, vol. 29, no. 10, p. 2281). The values of the phenomenological coefficients were determined by fitting the theoretical curve to the experimental data obtained for 20 kPa. The values of coefficients for 40 and 60 kPa were calculated by respectively (2 and 3 times) increasing the value of the initial permeate velocity in their expressions.

The approximation of the deadend filter experimental kinetic curves showed that the mathematical model accurately describes the decline in permeate velocity for all four experiments. As the permeate velocity is a single-valued function of the mass of deposited particles per unit membrane outside surface area, the mathematical model can accurately describe the deposition rate of suspended particles on the outside surface of hollow fibers in outside-in HFM filters such as HFM adsorbers.

The mathematical model with the phenomenological coefficients obtained from the first experiment was then used to evaluate the performance of an HFM adsorber whose only difference from the deadend HFM filter (Lim A. L. and Bai R., J. Membr. Sci. 2003, vol. 216, nos. 1-2. p. 279) is the presence of the second clarified product stream: filtrate. In the flow diagram in FIG. 1, this operation corresponds to the open control valve 5, while the closed valve corresponds to the deadend operation. In our calculations, it was assumed that the feed flow rate is maintained constant at constant TMP. This implies that the decline in permeate flow rate is compensated by the equal increase in filtrate flow rate adjusted by the control valve 5.

FIGS. 2 and 3 present the profiles of SP concentration and specific deposit in the adsorber when the constant feed flow rate is equal to the initial permeate flow rate. It is clearly seen that the profiles of SP concentration and specific deposit are much like the classical profiles in adsorbent columns and filtration beds. The suspended particles begin to deposit onto the outer layers of hollow fibers, with the deposit front moving on to the inner HFM layers. The filtrate can be withdrawn as clarified water for a quite long period, increasing the clarified product rate of the HFM filter. In other words, the HFM adsorber can be a membrane filter providing a constant product (permeate plus filtrate) flow rate at constant TMP with a power consumption as low as that for a conventional deadend outside—in HFM filter.

As it follows from Table 1, in which the separation cycle is terminated for backflushing when the product SP concentration reaches 10% of the feed concentration, the adsorber achieves a maximum efficiency (longest duration of separation cycle) when the constant feed flow rate is equal to the initial permeate flow rate. This is true for continuous flow and batch operations. In Table 1, w₀ is the feed velocity, V₀ the initial permeate velocity, ξ₀ the ratio of feed to initial permeate flow rates, tₒₚ the separation cycle duration, and ξ₀Vₐᵥ/V₀ the proportion of permeate in the product; the product consists of both the filtrate and permeate and the ratio of average permeate velocity to initial permeate velocity multiplied by the ratio of initial permeate to feed flow rates is equal to the fraction of permeate in the product. The data in Table 1 also demonstrate that the greatest product volume, which is equal to the product of linear feed velocity (remaining constant in each separation cycle), filter cross section area (being the same in all calculations), and separation cycle duration, can be achieved at the lowest TMP. For example, the volume at the lowest TMP is about 30% higher than that for the double TMP. It also implies that, given the same constant product flow rate, the separation cycle duration of two adsorbers will be about three times longer than that of one adsorber operated under double TMP. This fact may be of great importance in optimizing the design of multistage plants of HFM adsorbers. Finally, it can be seen from Table 1 that, owing to the filtrate stream, an HFM adsorber would be able to produce approximately twice as much clarified water as a deadend filter with the same characteristics.

TABLE 1
Performance of HFM adsorber at various TMP in continuous flow (CF)
and batch (B) operations (Polyakov Yu. S., Membr. Q., 2005, vol. 20,
No. 3, pp. 7-11). Here, V₀ = 6.94 × 10⁻⁵ m/s
corresponds to the experimental data of (Lim A. L. and Bai R.,
J. Membr. Sci., 2003, vol. 216, nos. 1-2. p. 279).

| W₀ × 10⁴, | V₀ × 10⁵, | | tₒₚ, s | ξ₀Vₐᵥ/V₀ | tₒₚ, s | ξ₀Vₐᵥ/V₀ |
|---|---|---|---|---|---|---|
| m/s | m/s | ξ₀ | (CF) | (CF) | (B) | (B) |
| 4.48 | 1.16 | 0.50 | 9316 | 0.239 | 14865 | 0.176 |
| 2.98 | 1.16 | 0.75 | 18870 | 0.347 | 27637 | 0.256 |
| 2.26 | 1.16 | 0.99 | 30267 | 0.455 | 41445 | 0.339 |
| 8.97 | 2.31 | 0.50 | 2656 | 0.267 | 4557 | 0.206 |
| 5.96 | 2.31 | 0.75 | 6634 | 0.355 | 10454 | 0.265 |
| 4.53 | 2.31 | 0.99 | 11518 | 0.451 | 16897 | 0.335 |
| 13.45 | 3.47 | 0.50 | 910 | 0.322 | 1542 | 0.267 |
| 8.95 | 3.47 | 0.75 | 3176 | 0.378 | 5164 | 0.292 |
| 6.80 | 3.47 | 0.99 | 6055 | 0.461 | 9216 | 0.348 |
| 26.91 | 6.94 | 0.50 | — | — | — | — |
| 17.89 | 6.94 | 0.75 | 502 | 0.524 | 729 | 0.469 |
| 13.59 | 6.94 | 0.99 | 1562 | 0.542 | 2359 | 0.447 |

Table 2 demonstrates that an increase in the adsorptive capability of hollow fiber membranes with respect to suspended particles, given the same all other process parameters, can cause a considerable improvement in the HFM adsorber performance. For example, as the coefficient of deposition f increases twice, the product volume increases about 3.3 times. This results from the fact that the higher the coefficient of deposition, the higher the rate of particle deposition on the outer hollow fibers and the cleaner the rest of the adsorber. The latter causes a higher averaged permeate flow rate and a lower SP concentration in the filtrate. It should be noted that the separation (filtration) cycle duration of almost half an hour between flushings, which was calculated for the HFM adsorber equipped with a bunch of hollow fibers made of a commercial low-adsorption polymer as were used in (Lim A. L. and Bai R., J. Membr. Sci., 2003, vol. 216, nos. 1-2. p. 279), is about the same as those in modern commercial deadend membrane systems. At the same time, increasing the deposition coefficient, which can be effected by using high-adsorption materials for membranes, varying the ionic strength and pH of the slurry and so on, could provide us with a great potential for improving the performance of outside-in HFM filters.

TABLE 2
Performance of HFM adsorber at various collection capabilities of HF
membranes with respect to suspended particles at ξ₀ = 0.99
(Polyakov Yu. S., Membr. Q., 2005, vol. 20, No. 3, pp. 7-11).
Here, β = 1.81 × 10⁻⁴ m/s is the value obtained
from the deadend experiment (Lim A. L. and Bai R., J. Membr. Sci.,
2003, vol. 216, nos. 1-2. p. 279).

| | tₒₚ, s | Vₐᵥ/V₀ | tₒₚ, s | Vₐᵥ/V₀ |
|---|---|---|---|---|
| β × 10⁴, m/s | (CF) | (CF) | (B) | (B) |
| 1.81 | 1562 | 0.542 | 2359 | 0.447 |
| 3.61 | 5318 | 0.367 | 8350 | 0.262 |
| 5.42 | 9895 | 0.317 | 15142 | 0.217 |

### EXAMPLE

A three-stage plant with HFM adsorbers, in which the filtrate leaving the first-stage adsorber is used as the feed to the second stage adsorbers and the second-stage filtrate as the feed for the third-stage adsorber, makes it possible to achieve very high particle retentions and water recoveries (FIG. 4). For example, when the particle retention in an HFM adsorber is 90%, the second stage of the plant will provide a retention about 99%. In this plant, the permeate exiting the adsorbers can be collected in a clean product tank. Obviously, the values of water recovery that could be reached in HFM adsorbers would be as high as those in deadend HFM filters. In contrast to a plant with deadend HFM filters operated at constant pressure, in which the product flow rate declines with time, a plant with HFM adsorbers will provide a constant product flow rate at constant pressure.

The plant schematically depicted in FIG. 4 can be operated as follows.

Separation mode: Valves 1, 2, 11, 14, 16, 21, 24, and 25 are open. Valves 9, 10, 12, 15, 17, 19, 20, and 22 are closed. The feed from tank 4 is supplied by pump 7 at constant pressure and flow rate to the inlets of first-stage HFM adsorbers 3. The permeate withdrawn from HFM adsorbers 3 is collected in permeate tank 8 while the filtrate from HFM adsorbers 3 goes to first-stage filtrate tank 5. Control valve 2 maintains the constant pressure and flow rate in the first stage by increasing the filtrate flow rate by an amount compensating the decline with time of permeate flow rate caused by the cake formation and growth on the HFM shells.

The first-stage filtrate from tank 5 is supplied by pump l3 at constant pressure and liquid flow rate to the inlets of second-stage HFM adsorbers 18. The permeate withdrawn from HFM adsorbers 18 is collected in permeate tank 8 while the filtrate from HFM adsorbers 18 goes to second-stage filtrate tank 6. Control valve 21 maintains the constant pressure and liquid flow rate in the second stage by increasing the filtrate flow rate by an amount compensating the decline with time of permeate flow rate caused by the cake formation and growth on the HFM shells.

The second-stage filtrate from tank 6 is supplied by pump 26 at constant pressure and liquid flow rate to the inlets of third-stage HFM adsorber 23. The permeate withdrawn from HFM adsorber 23 is collected in permeate tank 8 while the filtrate from HFM adsorber 23 goes to a collector of clean liquid. Control valve 24 maintains the constant pressure and liquid flow rate in the third stage by increasing the filtrate flow rate by an amount compensating the decline with time of permeate flow rate caused by the cake formation and growth on the HFM shells.

The separation mode gets terminated when the plant retention declines to a specified value. The plant operation switches to a backwash mode.

Backwash mode: Valves 9, 10, 12, 15, 17, 19, 20, and 22 are open. Valves 1, 2, 11, 14, 16, 21, 24, and 25 are closed.

Compressed air is supplied via valves 10 and 17 to the HFM lumens and passes through membrane pores to make the cake layer loose.

The filtrate from tank 5 is supplied at a high liquid flow rate and low pressure (less than the pressure of compressed air) by pump 13 via valve 12 to HFM adsorbers 3 for backwashing. The backward flow carries away the detached cake via valve 9 to tank 4.

The filtrate from tank 6 is supplied at a high liquid flow rate and low pressure (less than the pressure of compressed air) by pump 26 via valve 22 to HFM adsorber 23 for backwashing. The backward flow carries away the detached cake via valve 20 to tank 4.

The filtrate from tank 6 is supplied at a high liquid flow rate and low pressure (less than the pressure of compressed air) by pump 26 via valves 22 and 19 to HFM adsorber 18 for backwashing. The backward flow carries away the detached cake via valve 15 to tank 4.

After the backwashing is finished, the plant is switched back to the separation mode.

What is claimed is:

1. A micro- or ultrafiltration process using a membrane module consisting of hollow fiber, tubular, or capillary membranes, comprising
(a) feeding the liquid to be treated in the space between the membranes;
(b) withdrawing the permeate, a product stream which is obtained by passing the liquid under the action of pressure gradient through the pores of said membranes from the outsides thereof to the insides thereof to trap the colloidally suspended particles on the outer surfaces and/or inside the pores of said membranes, from the inside of said membranes;
(c) withdrawing the filtrate, a product stream which is obtained by collection of said particles on the outside surface of said membranes due to adsorption and/or other particle collection mechanisms, under the action of pressure difference across a control valve, or any other flow control device, at the filter outlet.

2. A process with multiple stages of the process according to claim 1, wherein the filtrate on the previous stage is used as the feed for the following stage until the last stage.

3. A membrane module of any design implementing the process of claim 1.

4. A membrane module of claim 3, wherein the membranes are made of a material possessing a high adsorptive capability with respect to the particles suspended in the feed liquid.

5. A filtration system implementing the process of claim 2.
